(19) United States
(12) Patent Application Publication
(10) Pub. No.: US 2026/0321490 A1
(43) Pub. Date: Oct. 15, 2026

(54) METHOD FOR PREPARING LEADLESS TERMINAL INTEGRATED CHIP INDUCTOR

(71) Applicant: Cyge Electronic Technology (Hunan) Co., Ltd., Loudi (CN)

(72) Inventors: Liliang Su, Loudi (CN); Xueyuan Su, Loudi (CN); Shuhua Song, Loudi (CN); Tao Liu, Loudi (CN); Di Liu, Loudi (CN); Mingyang Liu, Loudi (CN); Qingshou Long, Loudi (CN); Mingsong Liu, Loudi (CN)

(21) Appl. No.: 19/263,593

(22) Filed: Jul. 9, 2025

(30) Foreign Application Priority Data
Apr. 11, 2025 (CN) 202510451833.8

(51) Int. Cl. H01F 41/00; H01F 41/02; H01F 41/064; H01F 41/10

(52) U.S. Cl. CPC H01F 41/005; H01F 41/0246; H01F 41/064; H01F 41/10

(57) ABSTRACT

The present disclosure provides a method for preparing a leadless terminal integrated chip inductor, comprising: S1, multi-axis winding an air-core coil on a winding fixture, and fixing the air-core coil onto a conductive strip; S2, positioning the conductive strip containing the air-core coil into a mold cavity of a molding machine; S3, subjecting the inductor green body to a hot-press curing treatment, wherein a temperature of the hot-press curing is not lower than 100° C., a pressure is not less than 0.5 MPa, and a hot-press curing time is not less than 5 minutes; S4, forming an insulating layer with a thickness of not less than 3 μm on a surface of the inductor green body using a high-atomization spraying process; S5, exposing coil end portions of the inductor green body by a laser de-molding; S6, forming external electrodes by sequentially depositing a copper layer; and S7, cutting the conductive strip.

### CROSS-REFERENCE TO RELATED APPLICATIONS

This application claims priority to Chinese Patent Application No. 202510451833.8, filed on Apr. 11, 2025, which is incorporated herein by reference in its entirety.

### TECHNICAL FIELD

The present disclosure relates to the technical field of integrated inductors, in particular to a method for preparing a leadless terminal integrated chip inductor.

### BACKGROUND

To support advancements in hybrid and battery-powered systems for the automotive industry, an increasing number of Electronic Control Units (ECUs) are required to enhance control over various aspects of vehicle operation. As the quantity of ECUs increases, the average size of each ECU must be reduced to fit within limited available space. Consequently, the number and/or size of power inductors used in ECUs must also decrease. Simultaneously, hybrid and battery-powered systems demand that power inductors have an operating voltage withstand capability transitioning from the traditional 12V to 48V, have broader operating temperature ranges, and have the ability to endure higher temperatures.

In traditional wire-wound metal core power inductors, lead copper sheets are bent from the product side to the bottom. The bending amplitude and copper sheet thickness increase product dimensions and restrict coil design, thereby limiting product performance. This configuration wastes printed circuit board space and reduces integrated circuit density. During the molding process, wire-wound coils are susceptible to extrusion and slippage, generating significant stress between the copper coil and copper sheet. This stress poses a risk of disconnection between electrodes and coils, resulting in low product reliability. Such limitations hinder performance in harsh environments and fail to meet market demands.

### SUMMARY

An objective of the present disclosure is to provide a method for preparing a leadless terminal integrated chip inductor, which features a rational structure and enables continuous automated production.

To achieve the above objective, the technical solution provided by the present disclosure is: A method for preparing a leadless terminal integrated chip inductor, comprising following steps:

S1, coil winding: multi-axis winding an air-core coil on a winding fixture, and fixing the air-core coil onto a conductive strip;

S2, isotropic mold forming: positioning the conductive strip containing the air-core coil into a mold cavity of a molding machine, injecting metal magnetic powder, and performing press forming to form an inductor green body;

S3, low-temperature programmed curing: subjecting the inductor green body to a hot-press curing treatment, wherein a temperature of the hot-press curing is not lower than 100° C., a pressure is not less than 0.5 MPa, and a hot-press curing time is not less than 5 minutes, to cure the inductor green body;

S4, atomized spraying: forming an insulating layer with a thickness of not less than 3 μm on a surface of the inductor green body using a high-atomization spraying process;

S5, internal electrode preparation: exposing coil end portions of the inductor green body by a laser de-molding or micro-precision grinding process to form internal electrodes;

S6, external electrode plating: forming external electrodes by sequentially depositing a copper layer, a nickel layer, and a tin layer using a barrel plating process or a reel-to-reel continuous electroplating process; and

S7, cutting the conductive strip, separating qualified inductors, and packaging the qualified inductors.

Preferably, in the step S1: the conductive strip comprises a copper conductive strip, wherein the copper conductive strip has a thickness of 0.1-0.3 mm and is provided with an array of strip positioning holes, and the array of strip positioning holes has a positioning accuracy of ±0.02 mm; and the copper conductive strip fixes the air-core coil thereon via stamping or welding, and is continuously conveyed to a next process.

Preferably, in the step S2: raw material components of the metal magnetic powder are mixed according to a weight ratio of carbonyl iron powder/alloy material to epoxy resin to acetone of 100:≤7:≤20 to achieve uniformity, maintained at a temperature of ≤80° C. for 1-3 hours, and then subjected to grinding and granulation; during the granulation process, additives are added, the additives comprise a binder and a mold release lubricant; the binder is a two-component epoxy resin adhesive; and the mold release lubricant is one or a mixture of zinc stearate and barium stearate; and
the metal magnetic powder satisfies a sphericity of ≥60%, and powder particle sizes satisfy: D50≤30 μm, D90≤90 μm, D10≤20 μm.

During preparation of the metal magnetic powder, additives are introduced in the ball milling process to enhance powder fluidity and filling uniformity. This step ensures low-pressure molding, low-temperature programmed curing, and guaranteed product performance.

D10 denotes the particle size at which the cumulative particle distribution is 10%, meaning that particles smaller than this size account for 10% of the total particle volume. D50 denotes the particle size at which the cumulative particle distribution is 50%. D50 is also called the median particle size or the median value particle size, which is a typical value representing the particle size magnitude. D90 denotes the particle size at which the cumulative particle distribution is 90%, meaning that particles smaller than this size account for 90% of the total particle volume.

A two-component epoxy resin adhesive serves as the binder. After granulation, zinc stearate, barium stearate, or other mold release lubricants are added. The addition of these additives enhances powder fluidity and filling uniformity, ensuring low-pressure molding, low-temperature programmed curing, and guaranteed product performance.

Preferably, the S1 specifically comprises:
continuously winding coils the winding fixture via an automatic winding machine, simultaneously removing an insulation film by laser from end portions of wires for connecting to the conductive strip, and fixing the wire ends onto the stamping-formed conductive strip via stamping or welding; and
continuously conveying the coils to a next process via the conductive strip, or using a rewinder to wind up or an unwinder to unwind to balance production rates.

The rewinder is used to perform winding operations on the conductive strip. During inductor preparation, the conductive strip serves as a medium for carrying and conveying products (such as inductor coils, inductor green bodies, etc.). The conductive strip needs to be neatly wound on a spool for storage, transportation, or use in subsequent processes.

The conductive strip is typically made of a conductive material, such as a copper strip. The conductive strip not only serves as a carrier for products, but may also participate in the electrical conduction of the inductors. Particularly in the structural design of leadless terminal, the conductive strip may directly form part of the inductor or be used to connect the inductor coil to external circuits.

The conductive strip is typically provided with positioning holes. These positioning holes are used to precisely control the position and orientation of the products on the production line. Through the positioning holes, the products can be accurately fed into molds, curing device, or other processing devices, ensuring machining precision and consistency.

During inductor preparation, inductor green bodies (i.e., inductor products that have not undergone final processing) are typically fixed on the conductive strip. The conductive strip serves as a carrier for the inductor green bodies and conveys the inductor green bodies from one process to the next until all processing steps are completed.

The conductive strip not only carries inductor green bodies, but may also participate in electrical connections of the inductors through its conductivity. In the structural design of leadless terminal, the conductive strip may be directly connected to the inductor coil, forming part of the inductor or being used to connect the inductor to external circuits.

The rewinder plays a role in balancing production rates during inductor preparation. When the production rate of a certain process is faster or slower, the rewinder can adjust the rhythm of the production line by winding or unwinding the conductive strip (and the inductor green bodies thereon), ensuring smooth operation of the entire production flow.

Preferably, the S2 specifically comprises:
during unwinding by an unwinder, continuously feeding the air-core coil into the mold cavity of the molding machine via the strip positioning holes, injecting the metal magnetic powder into the mold cavity via an external powder feeder to form the inductor green body, forming a notch via mold pressing at a position where a copper wire exits a surface of the inductor green body, and performing isotropic hot-press forming; and
after isotropic mold forming is completed, continuously conveying to a next process, or using a rewinder to wind up or an unwinder to unwind to balance production rates.

Preferably, the S3 specifically comprises:
unwinding by an unwinder, and continuously passing the inductor green body through a curing device via the strip positioning holes for low-temperature programmed curing and forming;
wherein a curing temperature is 100-150° C., a pressure is 0.5-2 MPa, and a curing time is 5-15 minutes; and
after curing is completed, continuously conveying to a next process, or using a rewinder to wind up or an unwinder to unwind to balance production rates.

Preferably, the S5 specifically comprises:
removing an insulating layer on surfaces of enameled copper wires at end portions of the inductor green body by a laser de-molding or micro-precision grinding process to form the internal electrodes;
preparing an electrode seed layer by continuous ion sputtering, coating or barrel plating of a conductive adhesive layer; and
continuously conveying to a next process, or using a rewinder to wind up or an unwinder to unwind to balance production rates.

Preferably, the S6 specifically comprises:
unwinding by an unwinder, and pulling the conductive strip via the strip positioning holes such that the conductive strip continuously passes through air above a plating solution for conductive positioning, while an inductor green body portion is continuously immersed in the solution and continuously passes through the solution for electroplating, to form the external electrodes on the surface of the inductor green body, wherein the solution is one or more of copper plating solution, nickel plating solution, tin plating solution, silver plating solution, and gold plating solution; and
continuously conveying to a next process, or using a rewinder to wind up or an unwinder to unwind to balance production rates.

Preferably, the S7 specifically comprises:
testing the inductors, and after testing, cutting qualified inductors off the strip using the notch formed during mold pressing, and then packaging the qualified inductors to complete the process.

Preferably, the inductor is a bottom electrode inductor or an L-shaped electrode inductor.

The preparation method of the present disclosure iterates technologies of existing products in the current industry, including slurry-sealed barrel-plated integrated molded inductors, copper sheet terminal electrode-type integrated molded inductors, and built-in T-shaped magnetic core leaf-swing wire-wound electrode products. The thin-film electrodes prepared by this scheme exhibit high reliability, reduce mounting dimensions of the product on circuit boards, increase mounting space on integrated circuit PCBs (Printed Circuit Board), and create favorable conditions for the highly integrated development of the integrated circuit industry; under the same size, the comprehensive performance of the product is significantly improved. This scheme is particularly suitable for manufacturing inductors with bottom thin-film electrodes or “L”-shaped thin-film electrodes and enables automated, continuous, and efficient production.

### BRIEF DESCRIPTION OF THE DRAWINGS

FIG. 1 is a process flowchart of a preferred embodiment of the present disclosure;

FIG. 2 is a process flowchart of Embodiment 1 of the present disclosure;

FIG. 3 is a process flowchart of Embodiment 2 of the present disclosure;

FIG. 4 is a process flowchart of Embodiment 3 of the present disclosure;

FIG. 5 is a schematic diagram of a bottom electrode product according to a preferred embodiment of the present disclosure;

FIG. 6 is a schematic diagram of an “L”-shaped electrode product according to a preferred embodiment of the present disclosure;

FIG. 7 is a schematic diagram of continuous plating for an integrated chip inductor of the present disclosure;

FIG. 8 is a cross-sectional view of a product structure according to a preferred embodiment of the present disclosure;

FIG. 9 is a schematic diagram of a bottom electrode product according to a preferred embodiment of the present disclosure;

FIG. 10 is a cross-sectional view of a product structure according to a preferred embodiment of the present disclosure.

### DETAILED DESCRIPTION OF THE EMBODIMENTS

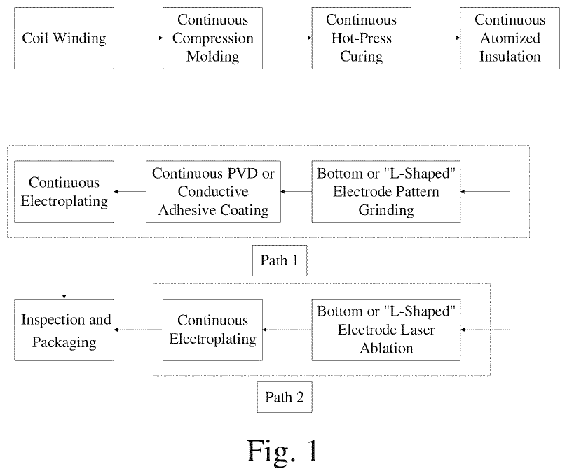

The present disclosure is further described below with reference to all drawings. Referring to FIG. 1 to FIG. 10, a process flowchart of a preferred embodiment of the present disclosure is shown in FIG. 1. The details are as follows:

### Embodiment 1

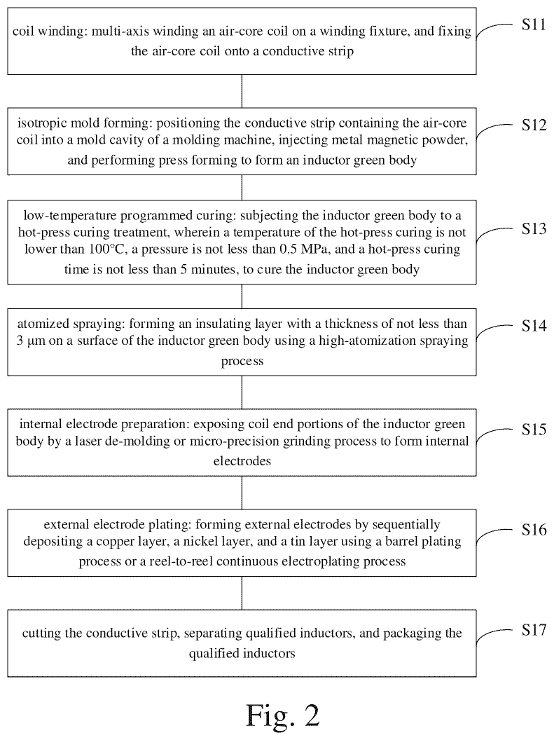

a bottom electrode is prepared in this embodiment; as shown in FIG. 1 and FIG. 2, by following Path 1 in the process flowchart of FIG. 1, the method comprises the following steps:

S11, coil winding: multi-axis winding an air-core coil on a winding fixture, and fixing the air-core coil onto a conductive strip;
during winding, the number of turns, wire diameter, and arrangement of the coil are precisely controlled according to design requirements of the inductor to ensure that the electrical performance meets design specifications. After winding, an insulation film is removed by laser from specified areas at end portions of the coil to expose conductive copper wires. Subsequently, the wound air-core coil is firmly fixed onto the conductive strip via stamping, welding, or positioning holes on the conductive strip. The conductive strip, made of highly conductive copper strip, serves not only as a carrier for the coil but also participates in electrical connections of the inductor in subsequent processes.

S12, isotropic mold forming: positioning the conductive strip containing the air-core coil into a mold cavity of a molding machine, injecting metal magnetic powder, and performing press forming to form an inductor green body;
the conductive strip containing the air-core coil is accurately fed into the mold cavity of the molding machine via positioning holes, ensuring that the coil is not damaged during forming. Subsequently, pre-mixed metal magnetic powder is uniformly injected into the mold cavity via an externally controlled automatic powder feeder. The metal magnetic powder comprises carbonyl iron powder, epoxy resin, acetone, and additives blended in specific proportions, exhibiting good fluidity and filling uniformity. Within the mold cavity, the metal magnetic powder is compacted by high-pressure stamping to form a preliminary inductor green body.

S13, low-temperature programmed curing: subjecting the inductor green body to a hot-press curing treatment, wherein a temperature of the hot-press curing is not lower than 100° C., a pressure is not less than 0.5 MPa, and a hot-press curing time is not less than 5 minutes, to cure the inductor green body;
the formed inductor green body is conveyed via the conductive strip to a low-temperature programmed curing device. Precise temperature and pressure control systems are employed in the curing device to ensure the hot-press curing temperature remains not lower than 100° C., the pressure remains not less than 0.5 MPa, and the curing time remains not less than 5 minutes. During curing, chemical reactions take place between binders and additives in the metal magnetic powder, solidifying the inductor green body and enhancing the mechanical strength and electrical performance. After curing, dimensional stability and reliability of the inductor green body are significantly improved.

S14, atomized spraying: forming an insulating layer with a thickness of not less than 3 μm on a surface of the inductor green body using a high-atomization spraying process. A layer of insulating material is uniformly applied by a high-atomization spraying process onto the surface of the cured inductor green body, forming an insulating layer with a thickness of not less than 3 μm. Material for the insulating layer is selected from high-performance insulating materials such as polyimide-based materials, exhibiting superior heat resistance, corrosion resistance, and electrical insulation properties. During spraying, spraying parameters are precisely controlled to ensure uniform thickness and absence of bubbles or defects in the insulating layer. After spraying, the inductor green body is transferred to a curing oven for curing, ensuring firm adhesion of the insulating layer to the inductor green body surface.

S15, internal electrode preparation: exposing coil end portions of the inductor green body by a laser de-molding or micro-precision grinding process to form internal electrodes. The insulating layer is precisely removed by a laser de-molding or micro-precision grinding process from specified areas at end portions of the inductor green body coil, exposing conductive copper wires to form internal electrodes. High-precision laser equipment is utilized in the laser de-molding process to accurately control the de-molding area and depth, preventing damage to the coil. Wear-resistant long-life CBN grinding tools are employed in the micro-precision grinding process to perform micro-grinding operations on the inductor green body, removing the insulating layer while maintaining flatness and conductivity of the coil end portions. After internal electrode preparation, dimensions and electrical performance of the internal electrodes are inspected via in-line inspection equipment to ensure compliance with design specifications.

S16, external electrode plating: forming external electrodes by sequentially depositing a copper layer, a nickel layer, and a tin layer using a barrel plating process or a reel-to-reel continuous electroplating process. Forming external electrodes by sequentially depositing a copper layer, a nickel layer, and a tin layer on surfaces of the internal electrodes of the inductor green body using a barrel plating process or a reel-to-reel continuous electroplating process. The barrel plating process is suitable for small-batch production; full contact between inductor green bodies and plating solution is ensured by rotation of a barrel for uniform coating. The reel-to-reel continuous electroplating process is suitable for mass production; inductor green bodies are continuously fed into plating tanks by the conductive strip for efficient, continuous plating. During plating, parameters including plating solution composition, temperature, and current density are strictly controlled to ensure uniform coating thickness, strong adhesion, and excellent conductivity and corrosion resistance.

S17, cutting the conductive strip, separating qualified inductors, and packaging the qualified inductors. In the final stage of inductor preparation, qualified inductors are individually separated from the conductive strip via cutting equipment. During the cutting process, notches formed during mold pressing or pre-defined cutting lines are utilized to perform precise cutting, ensuring dimensional and shape of the inductor products that meets design requirements. Separated inductor products undergo comprehensive inspection, including dimensional, visual, and electrical performance tests, to reject non-conforming products. Finally, qualified inductor products are packaged for storage and transportation. Anti-static and moisture-proof protective measures are implemented during packaging to ensure that the inductor products are not damaged during transit and storage.

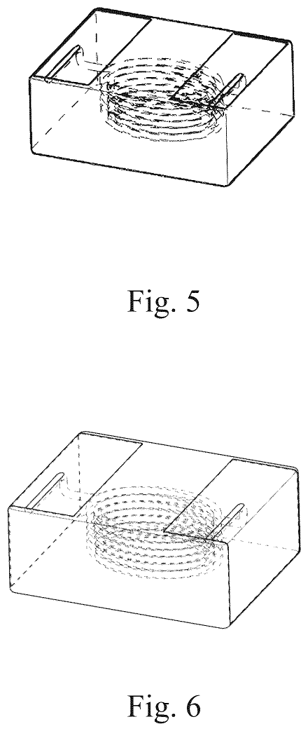

FIG. 5 is a schematic diagram of a bottom electrode product of the embodiment. FIG. 8 is a cross-sectional view of a product structure of this embodiment.

### Embodiment 2

a method for preparing a leadless terminal integrated chip inductor according to this embodiment comprises the following steps: coil winding, continuous isotropic mold forming, continuous low-temperature hot-press curing, continuous atomized spraying, continuous internal electrode preparation, continuous external electrode plating (copper/nickel/tin), and inspection and packaging;

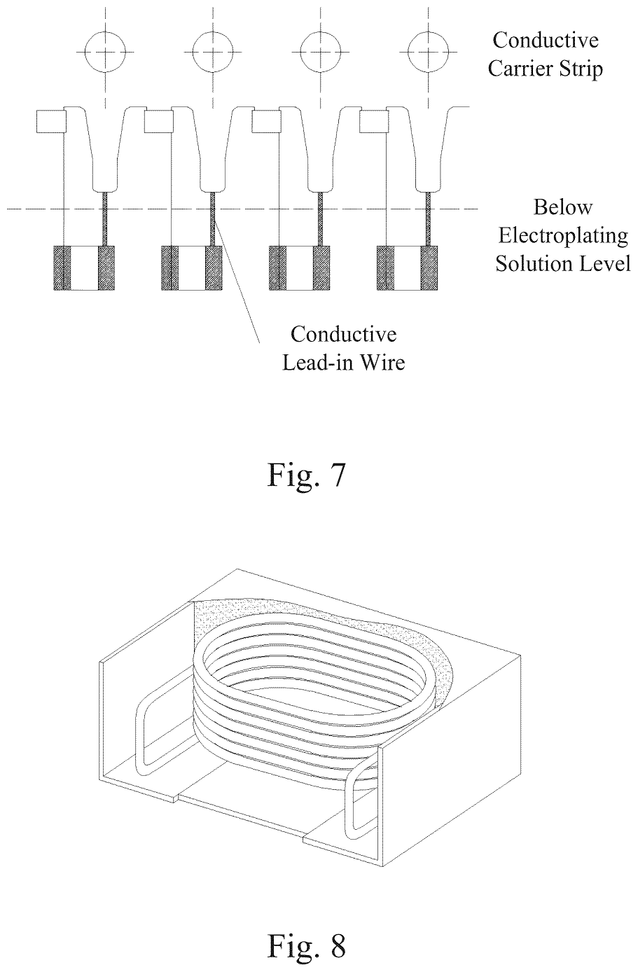

FIG. 7 is a schematic diagram of continuous plating for an integrated thin-film inductor of this embodiment. During electroplating, the conductive strip functions as both a carrier strip and a conductive strip; in other processes, the conductive strip serves solely as a carrier strip.

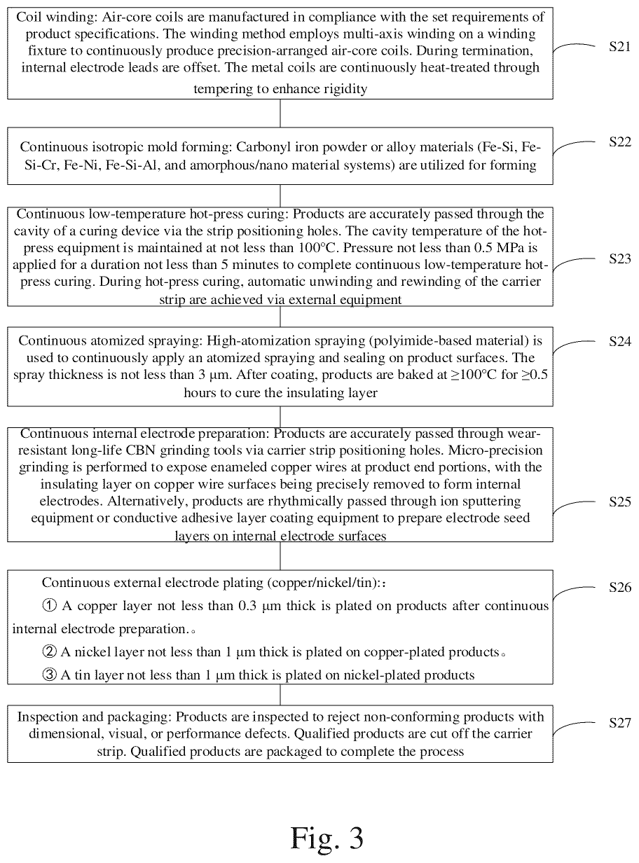

As shown in FIG. 3:

First Step S21: Coil winding: Air-core coils are manufactured in compliance with the set requirements of product specifications. The winding method employs multi-axis winding on a winding fixture to continuously produce precision-arranged air-core coils. During termination, internal electrode leads are offset. The metal coils are continuously heat-treated through tempering to enhance rigidity; relevant technical standards must be met. The selection of enameled copper wires and winding parameters was finalized through iterative experimentation, establishing specification data for mass-production winding equipment parameters and wire materials. Winding is carried out on an automated winding machine. Simultaneously, a copper strip is stamped into the designed structure, after which the coils are affixed to the formed carrier strip via stamping or welding and are continuously conveyed to the next process.

Second step S22: Continuous isotropic mold forming: Carbonyl iron powder or alloy materials (Fe—Si, Fe—Si—Cr, Fe—Ni, Fe—Si—Al, and amorphous/nano material systems) are utilized for forming. An optimal carbonyl powder composition formula is as follows:

Carbonyl iron powder/alloy material, epoxy resin, and acetone are blended at a weight ratio of 100:≤7:≤20 to achieve uniformity. The mixture is maintained at a temperature ≤80° C. for 1-3 hours. Subsequently, continuous internal electrode granulation is performed. The prepared powder must satisfy: sphericity ≥60%, and particle size distribution: D50≤30 μm, D90≤90 μm, D10≤20 μm. (D10 denotes the particle size at which the cumulative particle distribution is 10%, meaning that particles smaller than this size account for 10% of the total particle volume. D50 denotes the particle size at which the cumulative particle distribution is 50%. D50 is also called the median particle size or the median value particle size, which is a typical value representing the particle size magnitude. D90 denotes the particle size at which the cumulative particle distribution is 90%, meaning that particles smaller than this size account for 90% of the total particle volume.) A two-component epoxy resin adhesive serves as the binder. After granulation, zinc stearate, barium stearate, or other mold release lubricants are added. The addition of these additives enhances powder fluidity and filling uniformity, ensuring low-pressure molding, low-temperature programmed curing, and guaranteed product performance.

Based on the above embodiments, the metal magnetic powder may employ Formula 1 below:

Carbonyl iron powder (purity ≥99.5%), bisphenol-A epoxy resin, and acetone are blended at a weight ratio of 100:5:15. The blend is mixed at 75° C. under vacuum (vacuum ≤10 Pa) with stirring for 2 hours. The mixed powder is subjected to spray granulation to obtain spherical powder (sphericity ≥65%) with a particle size distribution of D10=18 μm, D50=25 μm, D90=85 μm. After granulation, 0.8 wt % zinc stearate is added as a mold release agent. Powder fluidity testing shows a Hall flow rate of 25 s/50 g.

Based on the above embodiments, the metal magnetic powder may employ Formula 2 below:

Fe—Si—Cr alloy powder (Fe-6.5Si-3.5Cr), modified epoxy resin, and acetone are blended at a ratio of 100:6:18. The blend is maintained at 70° C. under nitrogen protection for 2.5 hours. After centrifugal atomization granulation, powder with D10=15 μm, D50=22 μm, D90=78 μm (sphericity ≥70%) is obtained. After adding 1.2 wt % barium stearate, the apparent density of the powder reaches 2.95 g/cm³, meeting low-pressure molding requirements.

Based on the above embodiments, the metal magnetic powder may employ Formula 3 below:

Carbonyl iron powder, nano-silica modified epoxy resin, and acetone are blended at a ratio of 100:7:20. Ultrasonically assisted mixing is performed at 80° C. for 1 hour. A fluidized bed granulation process is adopted to obtain powder with D10=12 μm, D50=20 μm, D90=75 μm (sphericity ≥75%). A composite lubricant of 0.5 wt % zinc stearate and 0.5 wt % barium stearate is added. Testing shows a powder compression ratio of 2.8:1. This formula exhibits: optimal particle size distribution (D50=20 μm), highest sphericity (≥75%), excellent moldability (compression ratio 2.8:1), and favorable curing characteristics (complete curing at 120° C./5 min).

Based on the above embodiments, the metal magnetic powder may employ Formula 4 below:

Fe—Ni alloy powder (Fe-50Ni), low-temperature curing epoxy resin, and acetone are blended at a ratio of 100:4:16. The blend is mixed at 65° C. for 3 hours. After mechanical grinding granulation, powder with D10=20 μm, D50=28 μm, D90=88 μm (sphericity ≥60%) is obtained. After adding 1.0 wt % calcium stearate, the powder achieves a molded density of 3.1 g/cm³ under low pressure of 0.3 MPa.

Based on the above embodiments, the metal magnetic powder may employ Formula 5 below:

Amorphous Fe—Si—Al powder, fast-curing epoxy resin, and acetone are blended at a ratio of 100:5.5:17. High-shear mixing is performed at 78° C. for 1.5 hours. After plasma spheroidization treatment, powder with D10=10 μm, D50=18 μm, D90=70 μm (sphericity ≥80%) is obtained. 0.3 wt % silane coupling agent and 0.7 wt % zinc stearate are added. The powder exhibits an angle of repose ≤30°.

The carrier strip containing air-core coils is fed into a mold via a molding machine. During feeding, the air-core coils are precisely positioned into the mold cavity using positioning holes on the carrier strip. Metal magnetic powder is programmatically injected into the mold cavity via an externally controlled automatic powder feeder. The mold cavity is filled with metal magnetic powder and press forming is performed to create products. After isotropic hot-press forming, the carrier strip is automatically wound. The molded density is not less than 3 g/cm³.

Specific selection criteria for molding machine pressure: Excessive pressure may cause scratching or crushing of the enamel insulation of coils. Insufficient pressure results in low-density products, causing defects such as broken corners and low inductance values. Parameters that ensure product quality, production efficiency, and optimal yield rate are screened through extensive experimentation and statistical analysis.

Third step S23: Continuous low-temperature hot-press curing: Products are accurately passed through the cavity of a curing device via the strip positioning holes. The cavity temperature of the hot-press equipment is maintained at not less than 100° C. Pressure not less than 0.5 MPa is applied for a duration not less than 5 minutes to complete continuous low-temperature hot-press curing. During hot-press curing, automatic unwinding and rewinding of the carrier strip are achieved via external equipment.

In this embodiment, temperature, pressure, and time during curing may be controlled as follows:

(1) Standard curing process: curing is performed by adopting three-stage gradient heating:
preheating stage: 100-110° C./0.5 MPa/2 min;
main curing stage: 120-130° C./0.8 MPa/3 min;
stabilization stage: 110-115° C./0.6 MPa/2 min;
carrier strip transmission speed: 0.8 m/min, nitrogen protection (oxygen content ≤100 ppm);
post-curing product density: 3.15 g/cm³, dimensional stability: ±0.05 mm.

(2) High-pressure rapid curing, process parameters:
constant temperature: 125° C./1.2 MPa;
pressure holding time: 4 min;
infrared in-line monitoring of curing degree (≥95%);
curing time is reduced by 20% compared to conventional processes; product flexural strength is increased by 15%.

(3) Precision electronic-grade curing, multi-parameter control scheme:
temperature zoning control: inlet zone 105° C.→central zone 120° C.→outlet zone 110° C.;
pressure curve: 0.5 MPa (1 min)→0.8 MPa (2 min)→1.0 MPa (1 min)→0.6 MPa (1 min);
vacuum assistance: keeping chamber vacuum ≤50 Pa;
carrier strip positioning accuracy: ±0.01 mm;
product porosity ≤0.1%, suitable for automotive ECU devices.

(4) Hybrid curing process, combined curing methods:
initial stage: 100° C./0.5 MPa/1 min (hot-air convection);
main stage: 115° C./1.0 MPa/3 min (microwave-assisted);
final stage: 105° C./0.3 MPa/1 min (infrared radiation);
curing efficiency is increased by 30%; energy consumption is reduced by 25%.

Fourth step S24: Continuous atomized spraying: High-atomization spraying (polyimide-based material) is used to continuously apply an atomized spraying and sealing on product surfaces. The spray thickness is not less than 3 μm. After coating, products are baked at ≥100° C. for ≥0.5 hours to cure the insulating layer.

Fifth step S25: Continuous internal electrode preparation: Products are accurately passed through wear-resistant long-life CBN grinding tools via carrier strip positioning holes. Micro-precision grinding is performed to expose enameled copper wires at product end portions, with the insulating layer on copper wire surfaces being precisely removed to form internal electrodes. Alternatively, products are rhythmically passed through ion sputtering equipment or conductive adhesive layer coating equipment to prepare electrode seed layers on internal electrode surfaces. Automatic unwinding and rewinding are performed.

Sixth step S26: Continuous external electrode plating (copper/nickel/tin):
\textcircled{1} A copper layer not less than 0.3 μm thick is plated on products after continuous internal electrode preparation.
\textcircled{2} A nickel layer not less than 1 μm thick is plated on copper-plated products.
\textcircled{3} A tin layer not less than 1 μm thick is plated on nickel-plated products.

Seventh step S27: Inspection and packaging: Products are inspected to reject non-conforming products with dimensional, visual, or performance defects. Qualified products are cut off the carrier strip. Qualified products are packaged to complete the process.

Embodiment 3: An “L-shaped” electrode is prepared in this embodiment; Path 2 in the process flowchart of FIG. 1 is followed.

FIG. 6 is an “L”-shaped electrode product of this embodiment.

A method for preparing a leadless terminal integrated chip inductor according to this embodiment comprises the following steps: coil winding, continuous isotropic mold forming, continuous low-temperature hot-press curing, continuous atomized spraying, continuous internal electrode preparation, continuous external electrode plating, and inspection and packaging;

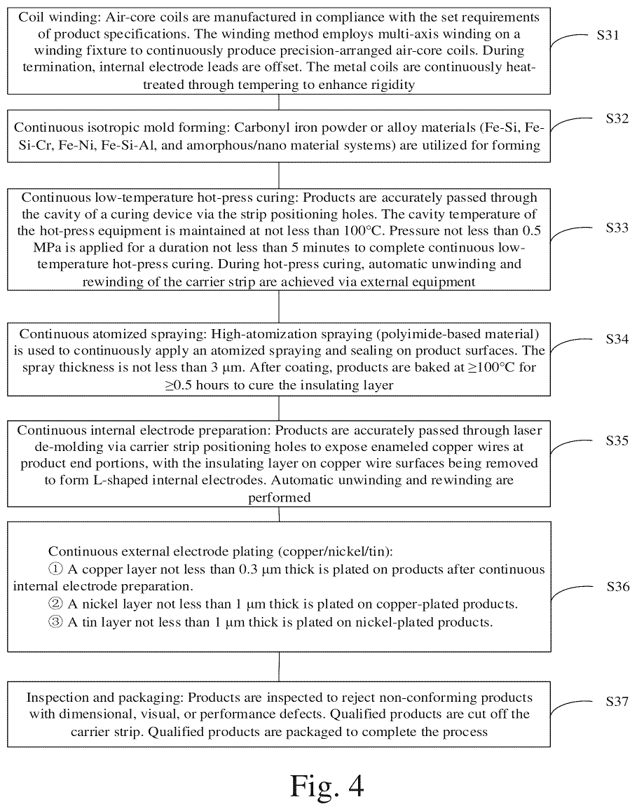

As shown in FIG. 4:

First Step S31: Coil winding: Air-core coils are manufactured in compliance with the set requirements of product specifications. The winding method employs multi-axis winding on a winding fixture to continuously produce precision-arranged air-core coils. During termination, internal electrode leads are offset. The metal coils are continuously heat-treated through tempering to enhance rigidity; relevant technical standards must be met. The selection of enameled copper wires and winding parameters was finalized through iterative experimentation, establishing specification data for mass-production winding equipment parameters and wire materials. Simultaneously, a copper strip is stamped into the designed structure, after which the coils are affixed to the formed carrier strip via stamping or welding and are continuously conveyed to the next process.

Second step S32: Continuous isotropic mold forming: Carbonyl iron powder or alloy materials (Fe—Si, Fe—Si—Cr, Fe—Ni, Fe—Si—Al, and amorphous/nano material systems) are utilized for forming. An optimal carbonyl powder composition formula is as follows:

Carbonyl iron powder/alloy material, epoxy resin, and acetone are blended at a weight ratio of 100:≤7:≤20 to achieve uniformity. The mixture is maintained at a temperature ≤80° C. for 1-3 hours. Subsequently, continuous internal electrode granulation is performed. The prepared powder must satisfy: sphericity ≥60%, and particle size distribution: D50≤30 μm, D90≤90 μm, D10≤20 μm. (D10 denotes the particle size at which the cumulative particle distribution is 10%, meaning that particles smaller than this size account for 10% of the total particle volume. D50 denotes the particle size at which the cumulative particle distribution is 50%. D50 is also called the median particle size or the median value particle size, which is a typical value representing the particle size magnitude. D90 denotes the particle size at which the cumulative particle distribution is 90%, meaning that particles smaller than this size account for 90% of the total particle volume.) A two-component epoxy resin adhesive serves as the binder. After granulation, zinc stearate, barium stearate, or other mold release lubricants are added. The addition of these additives enhances powder fluidity and filling uniformity, ensuring low-pressure molding, low-temperature programmed curing, and guaranteed product performance.

The carrier strip containing air-core coils is fed into a mold via a molding machine. During feeding, the air-core coils are precisely positioned into the mold cavity using positioning holes on the carrier strip. Metal magnetic powder is programmatically injected into the mold cavity via an externally controlled automatic powder feeder. The mold cavity is filled with metal magnetic powder and press forming is performed to create products. After isotropic hot-press forming, the carrier strip is automatically wound. The molded density is not less than 3 g/cm³.

Specific selection criteria for molding machine pressure: Excessive pressure may cause scratching or crushing of the enamel insulation of coils. Insufficient pressure results in low-density products, causing defects such as broken corners and low inductance values. Parameters that ensure product quality, production efficiency, and optimal yield rate are screened through extensive experimentation and statistical analysis.

Third step S33: Continuous low-temperature hot-press curing: Products are accurately passed through the cavity of a curing device via the strip positioning holes. The cavity temperature of the hot-press equipment is maintained at not less than 100° C. Pressure not less than 0.5 MPa is applied for a duration not less than 5 minutes to complete continuous low-temperature hot-press curing. During hot-press curing, automatic unwinding and rewinding of the carrier strip are achieved via external equipment.

Fourth step S34: Continuous atomized spraying: High-atomization spraying (polyimide-based material) is used to continuously apply an atomized spraying and sealing on product surfaces. The spray thickness is not less than 3 μm. After coating, products are baked at ≥100° C. for ≥0.5 hours to cure the insulating layer.

Fifth step S35: Continuous internal electrode preparation: Products are accurately passed through laser de-molding via carrier strip positioning holes to expose enameled copper wires at product end portions, with the insulating layer on copper wire surfaces being removed to form L-shaped internal electrodes. Automatic unwinding and rewinding are performed.

Sixth step S36: Continuous external electrode plating (copper/nickel/tin).
\textcircled{1} A copper layer not less than 0.3 μm thick is plated on products after continuous internal electrode preparation.
\textcircled{2} A nickel layer not less than 1 μm thick is plated on copper-plated products.
\textcircled{3} A tin layer not less than 1 μm thick is plated on nickel-plated products.

Seventh step S37: Inspection and packaging: Products are inspected to reject non-conforming products with dimensional, visual, or performance defects. Qualified products are cut off the carrier strip. Qualified products are packaged to complete the process.

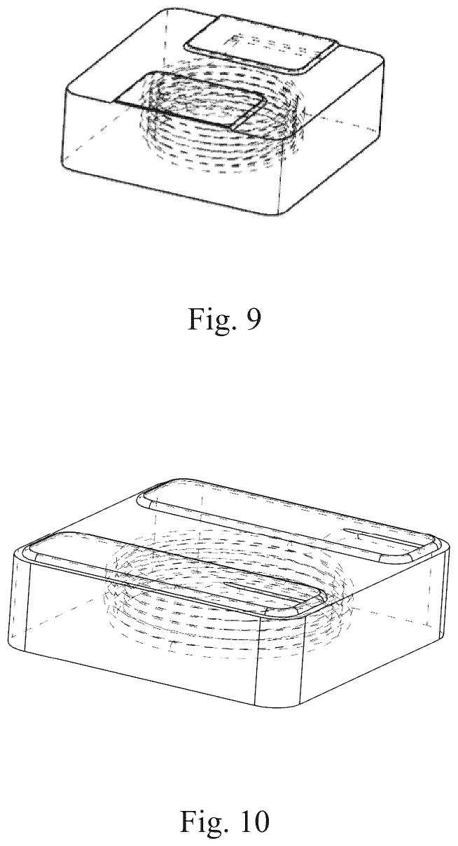

FIG. 9 is a schematic diagram of a bottom electrode product according to a preferred embodiment of the present disclosure; FIG. 10 is a cross-sectional view of a product structure according to a preferred embodiment of the present disclosure. The internal electrode process of this embodiment may also adopt one or a combination of two processes from conventional processes such as laser ablation, metal paste printing, or vacuum coating (ion sputtering technology) as needed.

The technical advantages of the present disclosure are as follows:
1) The preparation method of the present disclosure iterates traditional molded inductor technology, achieves reel-to-reel continuous manufacturing, and optimizes the preparation quality of thin-film external electrodes while reducing the preparation cost of external electrodes through continuous electroplating. Furthermore, products with broken copper wire coils during forming are automatically identified by differences in coating thickness appearance between left and right electrodes after plating. The product is reliable with highly integrated automation. Continuous production significantly reduces manufacturing costs, creates favorable conditions for highly integrated development in the integrated circuit industry, and facilitates mass production.
2) Reel-to-reel continuous immersion plating saves manufacturing costs. Specifically, traditional barrel plating for preparing thin-film electrodes is eliminated, the use of conductive media (conductive balls) is removed, anode material consumption in electroplating is greatly reduced, plating time is substantially shortened, manufacturing speed is increased, and the yield of finished electrodes approaches 100%.
3) The inductor prepared by this solution possesses advantages of high frequency, low loss, chip-scale miniaturization, compact size, high voltage resistance, and high reliability, fully complying with the development trend of high-end electronic components. The inductor has broad applications and can meet demands in industries including smart terminals, 5G, industrial internet, data centers, new energy vehicles, smart grids, aerospace, and high-speed rail.
4) The leadless terminal structural design uses inductor coil ends as carrier strips, saves terminal implantation steps, avoids connection contact between terminals and inductor coils, reduces welding issues between enameled wires of inductor coils and terminals, and resolves industry challenges.

The above-described embodiments are provided merely as preferred embodiments of the present disclosure, and shall not be used to limit the implementation scope of the present disclosure. Any modifications made in accordance with the shape and principles of the present disclosure shall be covered within the protection scope of the present disclosure.

What is claimed is:

1. A method for preparing a leadless terminal integrated chip inductor, comprising following steps:
S1, coil winding: multi-axis winding an air-core coil on a winding fixture, and fixing the air-core coil onto a conductive strip;
S2, isotropic mold forming: positioning the conductive strip containing the air-core coil into a mold cavity of a molding machine, injecting metal magnetic powder, and performing press forming to form an inductor green body;
S3, low-temperature programmed curing: subjecting the inductor green body to a hot-press curing treatment, wherein a temperature of the hot-press curing is not lower than 100° C., a pressure is not less than 0.5 MPa, and a hot-press curing time is not less than 5 minutes, to cure the inductor green body;
S4, atomized spraying: forming an insulating layer with a thickness of not less than 3 μm on a surface of the inductor green body using a high-atomization spraying process;
S5, internal electrode preparation: exposing coil end portions of the inductor green body by a laser de-molding or micro-precision grinding process to form internal electrodes;
S6, external electrode plating: forming external electrodes by sequentially depositing a copper layer, a nickel layer, and a tin layer using a barrel plating process or a reel-to-reel continuous electroplating process; and
S7, cutting the conductive strip, separating qualified inductors, and packaging the qualified inductors.

2. The method for preparing the leadless terminal integrated chip inductor according to claim 1, wherein in the step S1: the conductive strip comprises a copper conductive strip, wherein the copper conductive strip has a thickness of 0.1-0.3 mm and is provided with an array of strip positioning holes, and the array of strip positioning holes has a positioning accuracy of ±0.02 mm; and
the copper conductive strip fixes the air-core coil thereon via stamping or welding, and is continuously conveyed to a next process.

3. The method for preparing the leadless terminal integrated chip inductor according to claim 1, wherein in the step S2: raw material components of the metal magnetic powder are mixed according to a weight ratio of carbonyl iron powder/alloy material to epoxy resin to acetone of 100:≤7:≤20 to achieve uniformity, maintained at a temperature of ≤80° C. for 1-3 hours, and then subjected to grinding and granulation; during the granulation process, additives are added, the additives comprise a binder and a mold release lubricant; the binder is a two-component epoxy resin adhesive; and the mold release lubricant is one or a mixture of zinc stearate and barium stearate; and
the metal magnetic powder satisfies a sphericity of ≥60%, and powder particle sizes satisfy: D50≤30 μm, D90≤90 μm, D10≤20 μm.

4. The method for preparing the leadless terminal integrated chip inductor according to claim 1, wherein the S1 specifically comprises:
continuously winding coils on the winding fixture via an automatic winding machine, simultaneously removing an insulation film by laser from end portions of wires for connecting to the conductive strip, and fixing the wire ends onto the stamping-formed conductive strip via stamping or welding; and
continuously conveying the coils to a next process via the conductive strip, or using a rewinder to wind up or an unwinder to unwind to balance production rates.

5. The method for preparing the leadless terminal integrated chip inductor according to claim 1, wherein the S2 specifically comprises:
during unwinding by an unwinder, continuously feeding the air-core coil into the mold cavity of the molding machine via the strip positioning holes, injecting the metal magnetic powder into the mold cavity via an external powder feeder to form the inductor green body, forming a notch via mold pressing at a position where a copper wire exits a surface of the inductor green body, and performing isotropic hot-press forming; and
after isotropic mold forming is completed, continuously conveying to a next process, or using a rewinder to wind up or an unwinder to unwind to balance production rates.

6. The method for preparing the leadless terminal integrated chip inductor according to claim 1, wherein the S3 specifically comprises:
unwinding by an unwinder, and continuously passing the inductor green body through a curing device via the strip positioning holes for low-temperature programmed curing and forming;
wherein a curing temperature is 100-150° C., a pressure is 0.5-2 MPa, and a curing time is 5 -15 minutes; and
after curing is completed, continuously conveying to a next process, or using a rewinder to wind up or an unwinder to unwind to balance production rates.

7. The method for preparing the leadless terminal integrated chip inductor according to claim 1, wherein the S5 specifically comprises:
removing an insulating layer on surfaces of enameled copper wires at end portions of the inductor green body by a laser de-molding or micro-precision grinding process to form the internal electrodes;
preparing an electrode seed layer by continuous ion sputtering, coating or barrel plating of a conductive adhesive layer; and
continuously conveying to a next process, or using a rewinder to wind up or an unwinder to unwind to balance production rates.

8. The method for preparing the leadless terminal integrated chip inductor according to claim 1, wherein the S6 specifically comprises:
unwinding by an unwinder, and pulling the conductive strip via the strip positioning holes such that the conductive strip continuously passes through air above a plating solution for conductive positioning, while an inductor green body portion is continuously immersed in the solution and continuously passes through the solution for electroplating, to form the external electrodes on the surface of the inductor green body, wherein the solution is one or more of copper plating solution, nickel plating solution, tin plating solution, silver plating solution, and gold plating solution; and
continuously conveying to a next process, or using a rewinder to wind up or an unwinder to unwind to balance production rates.

9. The method for preparing the leadless terminal integrated chip inductor according to claim 1, wherein the S7 specifically comprises:
testing the inductors, and after testing, cutting qualified inductors off the strip using the notch formed during mold pressing, and then packaging the qualified inductors to complete the process.

10. The method for preparing the leadless terminal integrated chip inductor according to claim 1, wherein the inductor is a bottom electrode inductor or an L-shaped electrode inductor.
